(19) United States
(12) Patent Application Publication
(10) Pub. No.: US 2011/0286816 A1
(43) Pub. Date: Nov. 24, 2011

(54) FASTENER ASSEMBLY

(75) Inventor: Lawrence W. Johnson, Taylor, MI (US)

(73) Assignee: ILLINOIS TOOL WORKS INC., Glenview, IL (US)

(21) Appl. No.: 13/147,428

(22) PCT Filed: Jan. 6, 2010
(86) PCT No.: PCT/US10/20183

§ 371 Date: Aug. 2, 2011

Related U.S. Application Data
(60) Provisional application No. 61/149,401, filed on Feb. 3, 2009.

(51) Int. Cl. F16B 37/08

(52) U.S. Cl. 411/433

(57) ABSTRACT

A fastener assembly configured to provide secure column support between two components includes a base having at least one first cam member, and a connector nut having at least one second cam member. The connector nut is configured to rotatably move between closed and extended positions by way of the at least one second cam member rotatably sliding with respect to the at least one first cam member.

### RELATED APPLICATIONS

This application relates to and claims priority benefits from U.S. Provisional Patent Application No. 61/149,401 entitled “Stanchion Nut Fastener,” filed Feb. 3, 2009, which is hereby incorporated by reference in its entirety.

### FIELD OF EMBODIMENTS OF THE INVENTION

Embodiments of the present invention generally relate to a fastener assembly, and, more particularly, to a two-piece stanchion nut fastener assembly that is configured to provide secure column support between two components.

### BACKGROUND

Various objects and devices include components that are securely fastened to one another. For example, in a vehicle, instrument panels, sunroofs, headlights, door panels, etc. include numerous structures and sub-structures that are secured to one another. Often, clearance gaps exist between the components. As one example, a gap may be formed between a door panel and a frame of the vehicle. Insulation, wiring, and the like may be located within the gap. Accordingly, certain fasteners are used to securely fasten the door panel to the frame such that the gap is maintained therebetween.

Cold-headed, multi-piece fastener assemblies are used to provide such fastening. Typically, these conventional fasteners exhibit a relatively large profile and utilize an internal or external cold-headed thread. As such, in order to securely fasten components together, the components themselves, such as panels, typically require embossments in order to accommodate the fastener assemblies.

### SUMMARY OF EMBODIMENTS OF THE INVENTION

Certain embodiments of the present invention provide a fastener assembly configured to provide secure column support between two components. The fastener assembly includes a base having at least one first cam member, and a connector nut having at least one second cam member. The connector nut is configured to rotatably move between closed and extended positions by way of the at least one second cam member rotatably sliding with respect to (over or within, for example) the at least one first cam member.

The base may include a central opening. The connector nut may include a central column extending through the central opening. The central column, or stem, may include an internal threaded surface configured to receive a threaded end of a fastener, such as a bolt or screw. The connector nut rotatably moves between the closed and extended positions when the threaded end threadably engages the internal threaded surface.

The at least one first cam member may include a first recessed end integrally connected to a first peak through a first radially-curved ramp. The at least one second cam member may include a second recessed end integrally connected to a second peak through a second radially-curved ramp. Blunted ends of the first and second peaks may abut one another in the closed position. Further, a tip of one of the first and second peaks may be supported by another tip of the other of the first and second peaks in a fully-extended position.

The radially curved ramps may abut one another in the closed position. The radially curved ramps may be separated from one another in a fully-extended position.

The base may be separate and distinct from the connector nut. The base may be formed of a first material, such as aluminum, and the connector nut may be formed of a second material, such as steel.

In certain embodiments of the present invention, the at least one second cam member fits within a chamber defined by the at least first cam member.

The at least one first cam member may include two opposing first cam members, while the at least one second cam member may include two opposing second cam members. In certain embodiments of the present invention, the two opposing first cam members have different heights, and the two opposing second cam members have different heights.

In certain embodiments, the at least one second cam member includes a cam collar configured to fit over the at least one second cam member in the closed position.

Certain embodiments of the present invention provide a fastener that includes a base having first and second opposing cam members extending from a base main body about a central opening, and a connector nut having third and fourth opposing cam members extending from a nut main body. The connector nut is configured to rotatably move between closed and extended positions by way of the third and fourth opposing cam members rotatably sliding with respect to (for example, over or within) the first and second opposing cam members.

### BRIEF DESCRIPTION OF SEVERAL VIEWS OF THE DRAWINGS

FIG. 1 illustrates an isometric view of a fastener assembly from a first end, according to an embodiment of the present invention.

FIG. 2 illustrates an isometric view of a base of a fastener assembly from a second end, according to an embodiment of the present invention.

FIG. 3 illustrates an isometric view of a connector nut of a fastener assembly from a first end, according to an embodiment of the present invention.

FIG. 4 illustrates a lateral view of a fastener assembly in a closed position, according to an embodiment of the present invention.

FIG. 5 illustrates a transverse cross-sectional view of a fastener assembly in a closed position, according to an embodiment of the present invention.

FIG. 6 illustrates a lateral view of a fastener assembly in an extended position, according to an embodiment of the present invention.

FIG. 7 illustrates a transverse cross-sectional view of a fastener assembly in an extended position, according to an embodiment of the present invention.

FIG. 8 illustrates a transverse cross-sectional view of a fastener assembly in a closed position positioned between two panels, according to an embodiment of the present invention.

FIG. 9 illustrates a transverse cross-sectional view of a fastener assembly in an extended position between two panels, according to an embodiment of the present invention.

FIG. 10 illustrates an isometric view of a fastener assembly from a first end, according to an embodiment of the present invention.

FIG. 11 illustrates an isometric view of a base of a fastener assembly from a first end, according to embodiment of the present invention.

FIG. 12 illustrates an isometric view of a connector nut of a fastener assembly from a first end, according to an embodiment of the present invention.

FIG. 13 illustrates an isometric view of a fastener assembly in an extended position, according to an embodiment of the present invention.

FIG. 14 illustrates an isometric view of a fastener assembly in a closed position, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

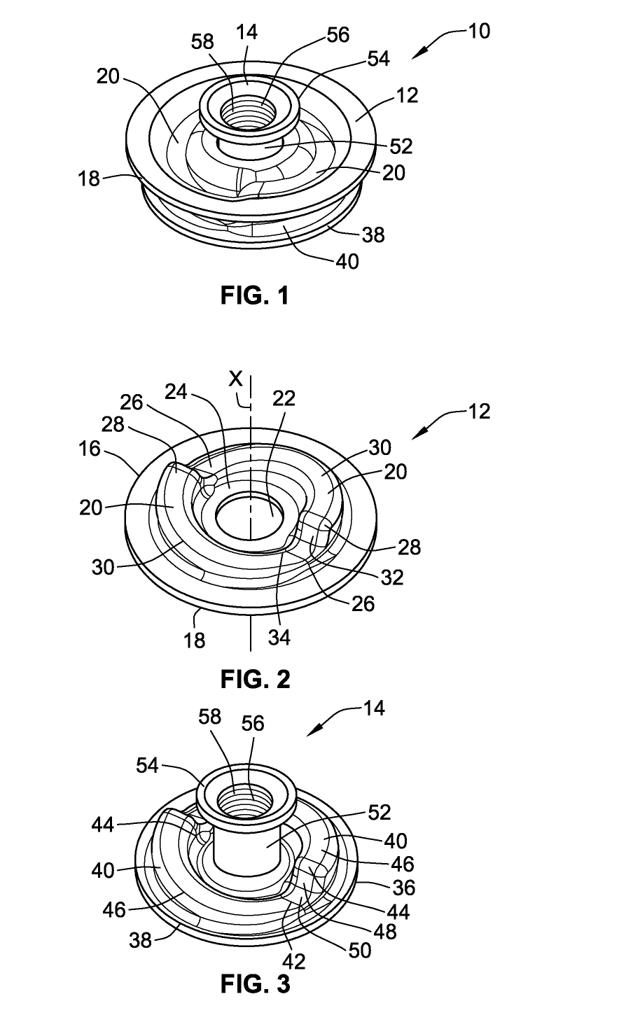

FIG. 1 illustrates an isometric of a fastener assembly 10, such as a stanchion nut fastener assembly, from a first end (such as a top or bottom end, depending on the current orientation of the fastener assembly), according to an embodiment of the present invention. The fastener assembly 10 includes a base or female connector 12 connected to a connector nut or male connector 14.

FIG. 2 illustrates an isometric view of the base 12 of the fastener assembly 10 from a second end. The base 12 includes a generally circular main body 16 having a generally planar rim 18, which may be configured to be welded to a panel. Opposing cam members 20 extend upwardly (as shown in FIG. 2) from inner edges of the rim 18. The cam members 20 surround a central opening 22 formed through and around a central axis X.

Each cam member 20 extends through an approximately 180° arc around a planar inner rim 24 surrounding the central opening 22. Each cam member 20 includes a recessed end 26 that connects to a peak 28 through a radially-curved ramp 30. The curved ramp 30 has a generally constant radius with respect to the center of the base 12 from the recessed end 26 to the peak. As shown in FIG. 2, the recessed end 26 of one cam member 20 is adjacent the peak 28 of the opposing cam member 20. The peak 28 of one cam member 20 transitionally connects to the recessed end 26 of the other cam member 20 through a blunted end 32 that connects to the recessed end 26 through an intermediate portion 34.

FIG. 3 illustrates an isometric view of the connector nut 14 of the fastener assembly 10 from a first end. The connector nut 14 includes a generally circular main body 36 having an outer planar rim 38. Opposing cam members 40 extend from the main body 36 similar to the cam members 20 of the base 12. Each cam member includes a recessed end 42 connected to a peak 44 through a radially-curved ramp 46. The curved ramp 30 has a generally constant radius with respect to the center of the connector nut 14 from the recessed end 42 to the peak 44. The peak 44 of one cam member 40 transitionally connects to the recessed end 42 of the other cam member 40 through a blunted end 48 that connects to the recessed end 42 through an intermediate portion 50.

A central column 52 upwardly extends from a center of the connector nut 14. The central column 52 connects to a flared distal end 54. The central column 52 is tubular having a central passage 56. Internal surfaces 58 of the column 52 are threaded. The central column 52 is configured to receive and retain a fastener, such as a bolt or screw.

Referring to FIGS. 1-3, the fastener assembly 10 is assembled so that the central column 52 of the connector nut 14 extends through the central opening 22 of the base 12. The flared distal end 54 of the connector nut 14 has a greater diameter than the central opening 22 of the base 12, thereby ensuring that the connector nut 14 does not disconnect from the base 12.

While the base 12 and the connector nut 14 are shown and described as generally circular, various other shapes and sizes may be used. Additionally, more or less cam members may be used.

The cam members 20 of the base 12 cooperate with the cam members 40 of the connector nut 14 to move the fastener assembly 10 between closed and extended positions, as discussed below.

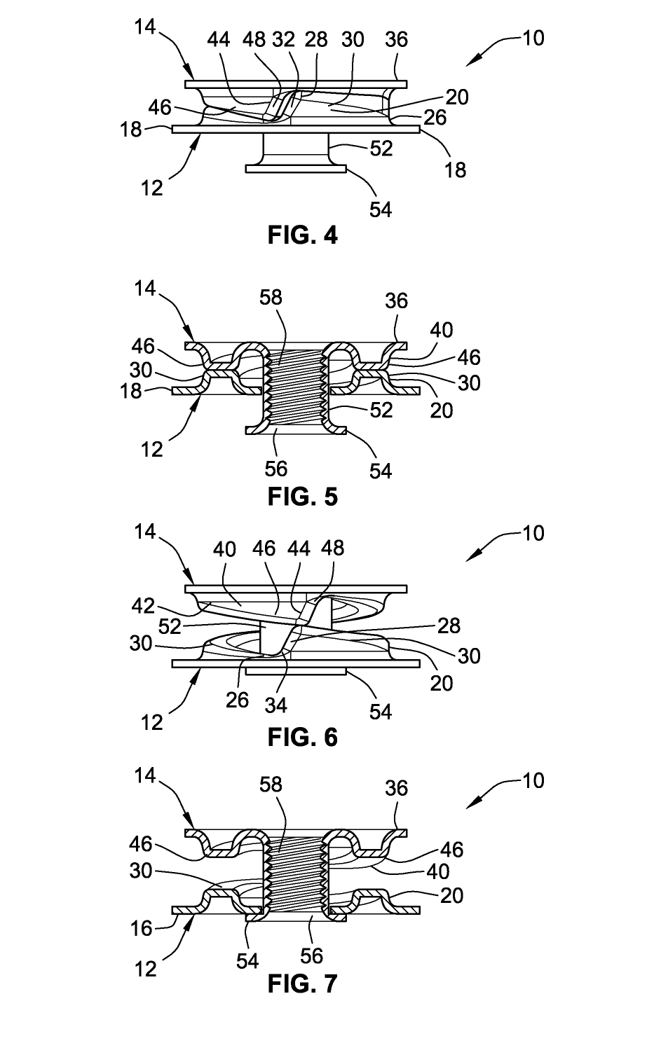

FIG. 4 illustrates a lateral view of the fastener assembly 10 in a closed position. FIG. 5 illustrates a transverse cross-sectional view of the fastener assembly 10 in the closed position. Referring to FIGS. 4 and 5, the base 12 and the connector nut 14 are connected to one another such that the blunted ends 32 of the cam members 20 of the base 12 abut the blunted ends 48 of the cam members 40 of the connector nut 14. In this position, the curved ramps 46 of the connector nut 14 rest on the curved ramps 30 of the base 12. Accordingly, the fastener assembly 10 is in a closed position such that there is little or no clearance between the cam members 20 and 40.

FIG. 6 illustrates a lateral view of the fastener assembly 10 in an extended position. FIG. 7 illustrates a transverse cross-sectional view of the fastener assembly 10 in the extended position. Referring to FIGS. 6 and 7, in the extended position, the cam surfaces 20 and 40 have rotatably slid over one another such that the curved ramps 30 of the base 12 no longer abut the curved ramps 46 of the connector nut 14. Instead, the tips of the peaks 28 of the base 12 abut the tips of the peaks 44 of the connector nut 14, thereby fully-extending the fastener assembly 10. As shown in FIG. 6, in particular, in the extended position, the blunted ends 32 and 48 no longer engage one another. Because the peaks 28 and 44 represent the maximum extending portions of the cam members 20 and 40, respectively, when the tips of the peaks 28 and 44 engage one another, the fastener assembly 10 is at its maximum extended position.

In order to selectively manipulate the fastener assembly between closed and extended positions, a fastener, such as a screw or bolt, is positioned within the central passage 56 of the connector nut 14 and rotatably engaged, as discussed below.

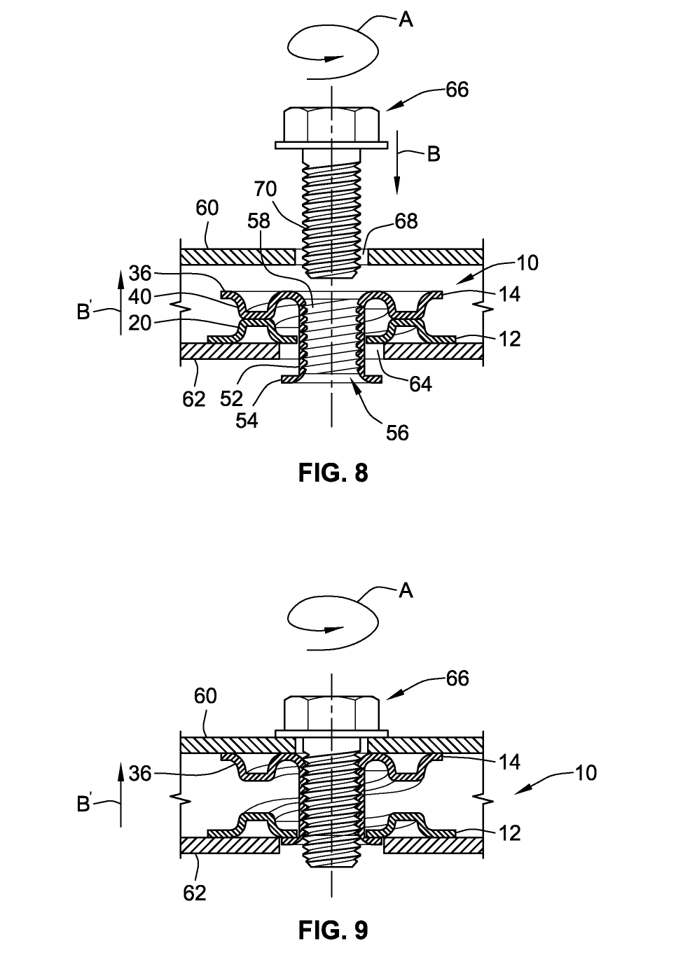

FIG. 8 illustrates a transverse cross-sectional view of the fastener assembly 10 in a closed position positioned between two panels 60 and 62, according to an embodiment of the present invention. The base 12 is secured to the panel 62, such as through welding. The central column 52 of the connector nut 14 passes through an opening 64 formed through the panel 62.

A fastener 66 is positioned within an opening 68 formed through the panel 60. The opening 68 is aligned with the opening 64 such that a threaded end 70 of the fastener 66 is aligned with the central passage 56 of the central column 52.

In order to provide a secure, bracing connection between the panels 60 and 62, the fastener is rotatably engaged in the direction of arc A. As the fastener is so engaged, the threaded end 70 moves into the central passage 56 of the connector nut 14 in the direction of arrow B. As the threaded end 70 engages the threaded internal threads 58 of the connector nut 14, the connector nut 14 rotates in response with respect to the base 12, which is fixed to the panel 62. As the connector nut 14 rotates, it responsively moves toward the panel 60 in the direction of arrow B′. During this motion, the cam members 20 and 40 slide over one another as explained with respect to FIGS. 4-7.

FIG. 9 illustrates a transverse cross-sectional view of the fastener assembly 10 in the extended position between the two panels 60 and 62, according to an embodiment of the present invention. Referring to FIGS. 8 and 9, the fastener 66 continues to be rotatably engaged until the main body 36 of the connector nut 14 contacts an underside of the panel 60. In this position, the fastener 66 may be torqued until it is no longer possible to rotate the fastener 66. Accordingly, the fastener assembly 10 is in a full securing position, and may be in the fully extended position discussed with respect to FIGS. 6 and 7.

As shown in FIGS. 1-9, the cam members 20 and 40 are generally the same size and shape. Therefore, as shown, outer portions of the cam members 20 and 40 rest upon and slide over one another.

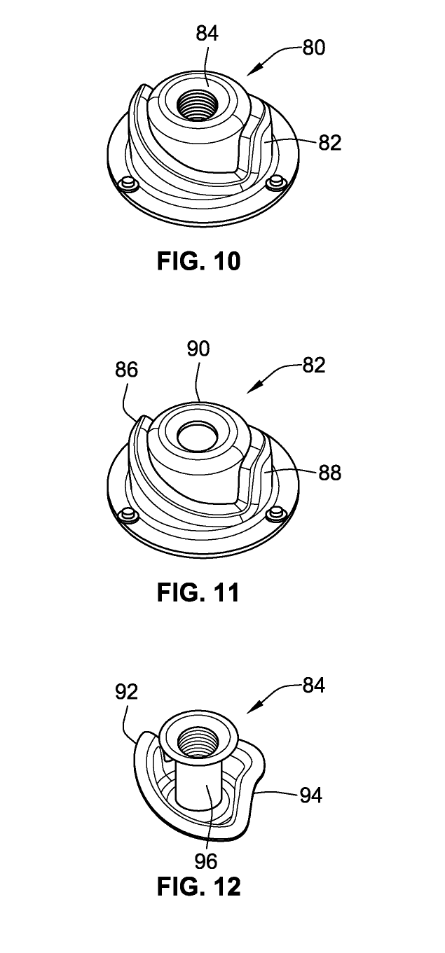

FIG. 10 illustrates an isometric view of a fastener assembly 80 from a first end, according to an embodiment of the present invention. The fastener assembly 80 includes a base 82 and a connector nut 84.

FIG. 11 illustrates an isometric view of the base 82 of the fastener assembly 80 from the first end. The base 82 includes opposing cam members 86 and 88 surrounding a central tube 90. As shown, the cam member 86 is higher than the cam member 88.

FIG. 12 illustrates an isometric view of the connector nut 84 of the fastener assembly 80 from the first end. The connector nut 84 includes cam members 92 and 94 surrounding a central column 96.

Referring to FIGS. 10-12, the cam members 92 and 94 are configured fit within internal chambers formed by the cam members 86 and 88, respectively. That is, the cam members 92 and 94 are dimensioned to reciprocally fit within the chamber formed by the cam members 86 and 88. Indeed, the cam members 92 and 94 may nestle within the inner chambers formed by the cam members 86 and 88 by way of an interference fit, thereby ensuring that the base 82 remains securely aligned with respect to the connector nut 84.

The cam members 92, 94, 86, and 88 cooperate for selectively moving the fastener assembly 80 between closed and extended positions, similar to that described with respect to FIGS. 1-9. However, instead of the abutting orientation of the cam members 20 and 40 shown with respect to FIGS. 1-9, the cam members 92 and 94 fit within the cam members 86 and 88 in the closed position, as shown in FIG. 10. Moreover, because the cam members 86 and 92 extend to a greater degree than the cam members 88 and 94, respectively, the fastener assembly 80 ensures that the connector nut 84 cannot be overrated into an undesired position. That is, when the connector nut 84 is rotated toward an extended position, the cam member 88 does not reciprocally receive the cam member 92. Because the cam member 92 is too high to be fully received by the internal chamber of the cam member 88, the fastener assembly is maintained in an extended position, even if over-rotated.

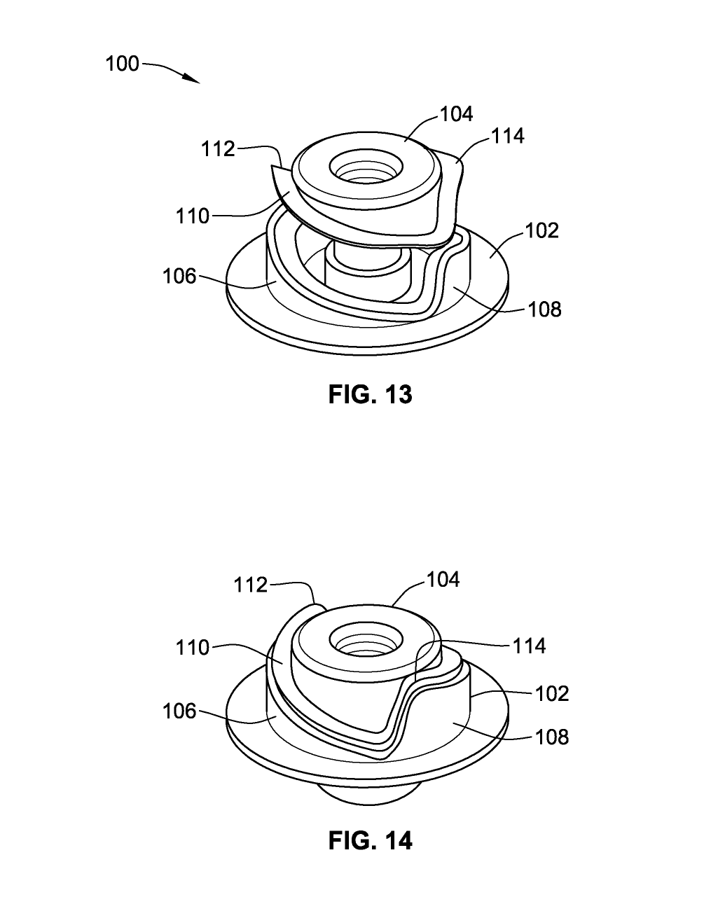

FIG. 13 illustrates an isometric view of a fastener assembly 100 in an extended position, according to an embodiment of the present invention. FIG. 14 illustrates an isometric view of the fastener assembly 100 in a closed position, according to an embodiment of the present invention. Referring to FIGS. 13 and 14, the fastener assembly includes a base 102 and a connector nut 104. The base 102 includes cam members 106 and 108. Cam member 106 may have a higher peak than cam member 108.

The connector nut 104 includes a cam collar 110 having a high peak 112 and a low peak 114. The high peak 112 seats on the cam member 106 in the closed position, while the low peak 114 seats on the cam member 108.

In contrast to the embodiment shown in FIGS. 10-12, the cam collar 110 of the connector nut 104 seats over the cam members 106 and 108 of the base 102. The cam collar 110 may nestle over the cam members 106 and 108 by way of an interference fit, thereby ensuring that the base 102 remains securely aligned with respect to the connector nut 104.

The different heights of the cam members 106 and 108 and peaks 112 and 114 may ensure that the connector nut 104 does not over-rotate with respect to the base 102. For example, the lower peak 114 may be blocked from further rotation by the higher cam member 106.

Thus, embodiments of the present invention provide a fastener assembly that may securely fasten one component to another component. Because the fastener assemblies provide a two-piece camming configuration, the fastener assemblies exhibit a lower profile than conventional one piece fastener assemblies. Further, the two-piece camming configuration allows for custom fits within varying sized-gaps. That is, the connector nut may be secured between panels with respect to the base over varying distances, depending on the size of the gap between panels. Therefore, the embodiments of the present invention may replace a variety of single piece fasteners having different heights. Moreover, embodiments of the present invention may replace two piece fasteners that include a column-like female receptacle and a conventional bolt-like fastener. Similar to single piece designs, such a configuration exhibits a relatively high profile, compared to embodiments of the present invention, which may be closed in a compact position.

The base and connector nut may be formed of stamped metal. Indeed, unlike conventional fasteners, the base and connector may be formed of different metals in order to provide different connection qualities. For example, the base may be formed of a metal, such as aluminum, that is suitable for welding to the panel, while the connector nut may be formed of a stronger metal, such as steel.

Embodiments of the present invention inherently have a lower profile shape as compared to previous designs. Accordingly, operators do not need stamped embossments on mating sheets in order to secure the sheets together. Moreover, it has been found that embodiments of the present invention are capable of carrying higher loads because of the robust cam surfaces.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A fastener assembly configured to provide secure column support between two components, the fastener assembly comprising:
a base having at least one first cam member; and
a connector nut having at least one second cam member,
wherein said connector nut is configured to rotatably move between closed and extended positions by way of said at least one second cam member rotatably sliding with respect to said at least one first cam member.

2. The fastener assembly of claim 1, wherein said base comprises a central opening, and said connector nut comprises a central column extending through said central opening, wherein said central column comprises an internal threaded surface configured to receive a threaded end of a fastener, and wherein said connector nut rotatably moves between the closed and extended positions when said threaded end threadably engages said internal threaded surface.

3. The fastener assembly of claim 1, wherein said at least one first cam member comprises a first recessed end integrally connected to a first peak through a first radially-curved ramp, wherein said at least one second cam member comprises a second recessed end integrally connected to a second peak through a second radially-curved ramp, wherein blunted ends of said first and second peaks abut one another in the closed position, and wherein a tip of one of said first and second peaks is supported by another tip of the other of said first and second peaks in a fully-extended position.

4. The fastener assembly of claim 3, wherein said radially curved ramps abut one another in the closed position, and wherein said radially curved ramps are separated from one another in a fully-extended position.

5. The fastener assembly of claim 1, wherein said base is formed of a first material, and said connector nut is formed of a second material.

6. The fastener assembly of claim 5, wherein said first material is aluminum and said second material is steel.

7. The fastener assembly of claim 1, wherein said at least one second cam member fits within a chamber defined by said at least first cam member.

8. The fastener assembly of claim 1, wherein said at least one first cam member comprises two opposing first cam members, and wherein said at least one second cam member comprises two opposing second cam members.

9. The fastener assembly of claim 8, wherein said two opposing first cam members have different heights, and wherein said two opposing second cam members have different heights.

10. The fastener assembly of claim 1, wherein said at least one second cam member comprises a cam collar configured to fit over said at least one second cam member in the closed position.

11. A fastener assembly configured to provide secure column support between two components, the fastener assembly comprising:
a base having first and second opposing cam members extending from a base main body about a central opening; and
a connector nut having third and fourth opposing cam members extending from a nut main body,
wherein said connector nut is configured to rotatably move between closed and extended positions by way of said third and fourth opposing cam members rotatably sliding with respect to said first and second opposing cam members.

12. The fastener assembly of claim 11, wherein said connector nut comprises a central column extending through said central opening of said base, wherein said central column comprises an internal threaded surface configured to receive a threaded end of a fastener, and wherein said connector nut rotatably moves between the closed and extended positions when said threaded end threadably engages said internal threaded surface.

13. The fastener assembly of claim 11, wherein each of said first and second opposing cam members comprises a first recessed end integrally connected to a first peak through a first radially-curved ramp, wherein each of said third and fourth opposing cam members comprises a second recessed end integrally connected to a second peak through a second radially-curved ramp, wherein blunted ends of one set of said first and second peaks abut one another in the closed position, and wherein a tip of one of said first and second peaks is supported by another tip of another of said first and second peaks in a fully-extended position.

14. The fastener assembly of claim 13, wherein said radially curved ramps abut one another in the closed position, and wherein said radially curved ramps are separated from one another in a fully-extended position.

15. The fastener assembly of claim 11, wherein said base is formed of a first metal, and said connector nut is formed of a second metal that is different from said first metal.

16. The fastener assembly of claim 11, wherein said third opposing cam member fits within a first chamber defined by said at first opposing cam member, and wherein said fourth opposing cam member fits within a second chamber defined by said second opposing cam member in the closed position.

17. The fastener assembly of claim 1, wherein said first and second opposing cam members have different heights, and wherein said third and fourth opposing cam members have different heights.

18. The fastener assembly of claim 1, wherein said third and fourth opposing cam members are formed on a cam collar configured to fit over said first and second opposing cam members in the closed position.

19. A fastener assembly comprising:
a base having first and second opposing cam members extending from a base main body about a central opening, wherein each of said first and second cam opposing members comprises a first recessed end integrally connected to a first peak through a first radially-curved ramp; and
a connector nut having third and fourth opposing cam members extending from a nut main body, wherein each of said third and fourth opposing cam members comprises a second recessed end integrally connected to a second peak through a second radially-curved ramp,
wherein said connector nut is configured to rotatably move between closed and extended positions by way of said third and fourth opposing cam members rotatably sliding with respect to said first and second opposing cam members, and wherein said radially curved ramps abut one another in the closed position, and wherein said radially curved ramps are separated from one another in a fully-extended position.

20. The fastener assembly of claim 19, wherein said connector nut comprises a central column extending through said central opening of said base, wherein said central column comprises an internal threaded surface configured to receive a threaded end of a fastener, and wherein said connector nut rotatably moves between the closed and extended positions when said threaded end threadably engages said internal threaded surface.

21. The fastener assembly of claim 19, wherein blunted ends of one set of said first and second peaks abut one another in the closed position, and wherein a tip of one of said first and second peaks is supported by another tip of another of said first and second peaks in a fully-extended position.

22. The fastener assembly of claim 19, wherein said base is formed of aluminum, and said connector nut is formed of a steel.

23. The fastener assembly of claim 19, wherein said third opposing cam member fits within a first chamber defined by said at first opposing cam member, and wherein said fourth opposing cam member fits within a second chamber defined by said second opposing cam member in the closed position.

24. The fastener assembly of claim 19, wherein said first and second opposing cam members have different heights, and wherein said third and fourth opposing cam members have different heights.

25. The fastener assembly of claim 19, wherein said third and fourth opposing cam members are formed on a cam collar configured to fit over said first and second opposing cam members in the closed position.
